(19) United States
(12) Patent Application Publication
(10) Pub. No.: US 2026/0018327 A1
(43) Pub. Date: Jan. 15, 2026

(54) POWER TRANSFORMER FOR ON-LOAD TAP CHANGER APPLICATION

(71) Applicant: Hitachi Energy Ltd, Zürich (CH)

(72) Inventors: Valentina Valori, Monselice (PD) (IT); Lorenzo Cantini, Albignasego (PD) (IT); Paolo Pavanello, Granze (PD) (IT)

(21) Appl. No.: 19/137,465

(22) PCT Filed: Dec. 1, 2023
(86) PCT No.: PCT/EP2023/083945

§ 371 Date: Jun. 10, 2025

(30) Foreign Application Priority Data
Dec. 14, 2022 (EP) 22213489.2

(51) Int. Cl. H01F 27/28; H01F 27/24; H01F 38/00

(52) U.S. Cl. CPC H01F 27/2885; H01F 27/24; H01F 38/00

(57) ABSTRACT

A power transformer for an on-load tap changer application is disclosed. The power transformer comprises a winding arrangement with a core, several windings wound around the core, and a shield located at an outer side of an outermost one of the windings, wherein the shield comprises or consists of a conductive or semiconductive material.

### CROSS REFERENCE TO RELATED APPLICATIONS

This application is a 35 U.S.C. § 371 national stage application of PCT International Application No. PCT/EP2023/083945 filed on Dec. 1, 2023, which in turn claims priority to European Patent Application No. 22213489.2, filed on Dec. 14, 2022, the disclosures and content of which are incorporated by reference herein in their entireties.

### DESCRIPTION

The present disclosure relates to a power transformer for on-load tap changer application.

During switching operations of an on-load tap changer (OLTC), main windings of a power transformer are connected and disconnected from regulation windings. Thereby, the tap changer may be subjected to high stress due to high recovery voltages. To keep the recovery voltage below a maximum level admitted for a specific OLTC design, so-called “tie-in resistors” can be provided. A tie-in resistor is an external additional device for recovery voltage's resistive control and it is also described in IEC/IEEE 60214-2, an international standard for tap changers. Additionally, “tie-in switch” devices may be used for disconnecting the resistors during continuous operations and avoiding additional losses during operation.

However, the dimensions and costs of power transformers increase when using tie-in resistors. Tie-in resistors and tie-in switches require additional space, which is often only available for larger tap changers' selectors, so that the impact of tie-in resistors is often higher for smaller units and smaller tap changer models. Increasing the dimensions for the tap changer also implies that a larger tank and a larger oil volume is needed to house the tap changer. When tie-in resistors are used without switches, losses, in particular no-load losses, increase. Furthermore, tie-in resistors may have an influence on the connected transformer's performances such as Peak Efficiency Index (PEI).

US 2021/057147 A1 discloses a tap changer assembly in which a semi-conductive coating and a conductive shield are applied to a cylindrical outside portion of a coil. DE 3534843 A1 discloses a winding arrangement for a transformer in which a regulating winding is covered by shield rings at the top and bottom of the end face. JP 59-126615 A discloses a winding arrangement for an on-load tap-changing transformer wherein an insulated shielding conductor is wound on an insulation cylinder, wherein both ends of the shielding conductor are connected to an end static shielding of a tap winding.

The publication by Dieter Dohnal: “On-Load Tap-Changers for Power Transformers” of Sep. 1, 2013 (Retrieved from the Internet on Dec. 7, 2017; https://www.reinhausen.com/XparoDownload.ashx? raid=58092) discloses a winding arrangement for an on-load tap changer application in which screens are installed between the windings to decrease recovery voltages. AT 260352 B discloses a winding arrangement of a transformer in which a capacitor formed by partial cylinders is provided for surge protection.

Embodiments of the disclosure relate to an improved power transformer for an on-load tap changer application.

According to a first aspect, a power transformer for an on-load tap changer application comprises a winding arrangement with a core, several windings wound around the core and a shield comprising a conductive or semiconductive material, wherein the shield is located at an outer side of an outermost one of the windings. The shield covers an angular range about a winding axis of the winding arrangement of at most 270°.

By the shield the level of recovery voltage can be reduced without tie-in resistors being required. The shield requires less space and reduces no-load losses when compared to using tie-in resistors.

As an example, the outermost winding may be a regulating winding comprising several lead exits for varying the transformer output voltage. Furthermore, the winding arrangement may comprise a primary winding and a secondary winding. The primary winding may be a high-voltage winding and the secondary winding may be a low-voltage winding. The secondary, primary and regulating winding may be wound on top of each other. The transformer may be a three-phase transformer. As an example, the core may comprise three wound limbs, wherein each limb is attributed to one phase.

The shield may be in the form of a layer of the conductive or semiconductive material. As an example, the shield may be in the form of a sheet metal. As a further example, the shield may be in the form of a layer of insulating material to which conductive or semiconductive particles are added to obtain a sufficient conductivity for electric screening.

It is also possible that the shield has openings. As an example, the shield may have a net-like structure. The geometry of the shield may be adapted to the geometry of the outermost winding. As an example, the shield may have a bent shape. The shield may have the shape of a cylinder. The cylindrical surface may have openings.

The shield may be connected to a ground potential or to the regulation neutral or center point potential.

The shield may circumferentially enclose the outermost winding except for a gap in order to prevent current flow circulation. The shield may cover at least an angular range of 45°.

In embodiments, the shield may be located only on one side of the winding arrangement. In this case, the shield may cover an angular range of at most 180° or of less than 180°. The shield may not extend into a space between adjacent wound limbs. In this case, the dimensions of the core and the distance between core limbs does not have to be increased.

The shield may have openings. The openings may be provided for lead exits. The lead exits may be led out through the openings to the tap changer contacts.

The shield may entirely or almost entirely cover the outermost winding in a direction along the winding axis. As an example, the shield may extend at least along 90% of the extension of the outermost winding along the winding axis.

The power transformer may comprise a tank, in which the winding arrangement is located. The power transformer may further comprise an on-load tap changer electrically connected to the winding arrangement. The on-load tap changer may also be located in the tank.

Further features, refinements and expediencies become apparent from the following description of the exemplary embodiments in connection with the figures. In the figures, elements of the same structure and/or functionality may be referenced by the same reference signs. It is to be understood that the embodiments shown in the figures are illustrative representations and are not necessarily drawn to scale.

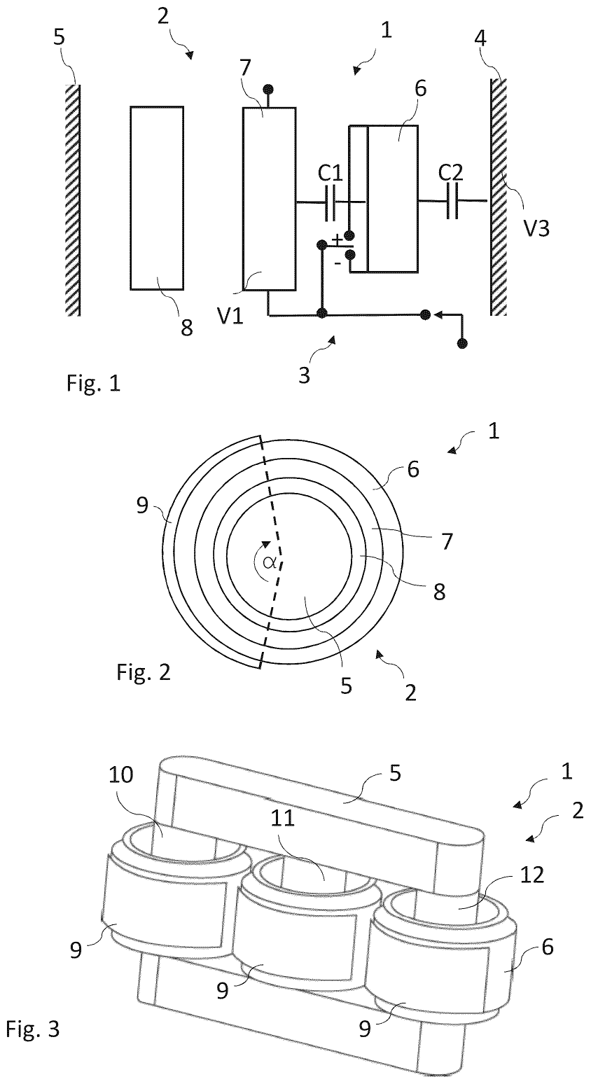

FIG. 1 shows a power transformer winding arrangement in a schematic diagram,

FIG. 2 shows a power transformer winding arrangement in a cross-sectional view,

FIG. 3 shows a power transformer winding arrangement in a perspective view,

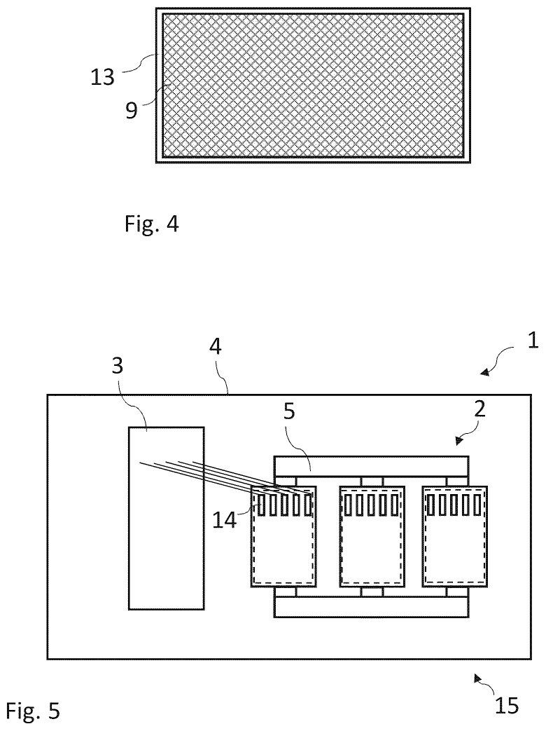

FIG. 4 shows one possible structure that can be used for the shield in a top view,

FIG. 5 shows a power transformer winding arrangement in an oil-filled tank in a schematic view.

FIG. 1 shows a schematic diagram of a power transformer 1 comprising a winding arrangement 2 for on-load tap changing. The winding arrangement 2 is connected to an on-load tap changer 3 and is located in an oil-filled tank comprising a tank wall 4.

The winding arrangement 2 comprises a core 5, around which several windings 6, 7, 8 are wound on top of each other. The outermost winding 6 is a regulating winding for varying the transformer output voltage. The regulating winding is connected to the tap changer 3. The regulating winding is arranged on an inner winding 7, which can be a high-voltage winding. The innermost winding 8 can be a low-voltage winding. Different arrangements of high-voltage, low-voltage and regulating winding are possible.

During a switching operation, the regulating winding is disconnected from and again connected to the high-voltage winding by the tap changer 3. When breaking the contacts in a switching operation, the tap changer may be subjected to high stress due to high recovery voltages. The regulation may be connected by a coarse-fine or plus-minus change-over selector, for example.

A main factor for the level of recovery voltage is the ratio between an internal capacitance C1 developed between the outermost winding 6 and the nearest innermost winding 7 and an internal capacitance C2 developed between the outermost winding 6 and the tank wall 4. As a general rule, the smaller the ratio C2/C1, the higher the recovery voltage developed on the change-over selector.

In FIG. 1, V1 is the potential to which the geometrical middle point of the nearest inner winding 7 is raised in service or is zero in case of the core limb. V3 is the potential to which the geometrical middle point of the nearest outer winding is raised in service or is zero in case of the tank wall 4.

FIG. 2 shows a schematic cross-sectional view of an embodiment of a winding arrangement 1. The winding arrangement 2 is as shown in FIG. 1 but with an additional shield 9 arranged at an outer side of the outermost winding 6. The shield 9 may consist of the conductive or semiconductive material or may be predominantly made from this material, apart from edge protections, for example. It is also possible that the shield 9 comprises an insulating material to which one or more conductive or semiconductive materials are added to obtain conductive or semiconductive properties and, thereby, a screening effect.

The shield 9 may be of a conductive material such as aluminum, for example. It is also possible that the shield 9 is of a semiconductive material. As an example, carbon may be used as a semiconductive material. The shield 9 may be made from an insulating paper to which conductive or semiconductive particles are added. The shield 9 may be a carbonized paper.

The shield 9 may consist of the conductive or semiconductive material or may be predominantly made from this material, apart from edge protections, for example. The shield 9 is external from the windings 6, 7, 8 wound around the core 5, i.e., it is not enclosed by a further winding wound around the respective core part. The shield 9 is a component in addition to the windings 6, 7, 8, in particular in addition to electrodes of the windings 6, 7, 8. The shield 9 may be in the form of a thin layer of conductive material. The geometry of the shield 9 is adapted to the outside surface of the outermost winding 6. The shield 9 may be in the form of an open cylinder. According to an example not in accordance with the claims, the cylinder can also be almost closed except from a small gap to prevent circular current flows.

The shield 9 is connected to ground potential or to the regulation neutral or center point potential. A center point potential may be a potential in a three-phase voltage system arranged into an equivalent star connection, for example. When the shield has the same potential as the regulation, is placed in the neutral end or is directly earthed, the potential difference between shield and regulation would be very low, enabling a closer distance between the shield and the windings. Thereby, voltage reflections or oscillations on the regulation itself during impulse distribution could be reduced, enabling a more compact and safe overall solution. The shield 9 acts as an outer “tank wall” as shown in the schematic drawing of FIG. 1. By the shield 9, the capacitance C2 can be strongly increased, leading to a decrease of recovery voltage value. When using the shield 9, additional tie-in resistors for reduction of the recovery voltage on the change-over selector are not required. The shield 9 provides a cost-effective and space-saving alternative for the tie-in resistors.

The shield 9 can cover only a part of the outermost winding 6. The shield 9 can be arranged only on one side of the winding arrangement 1. As an example, the shield 9 may cover an angular range a of less than 180° of a circumference of the winding arrangement 1. In other embodiments, the shield may cover 180° or more than 180° of the circumference. The shield 9 may cover an angular range of at least 45°. The geometry of the shield 9 can be such that a proximity with regulation lead exits is avoided.

The shield 9 can be covered from both sides by an insulating material, such as pressboard or paper layers. Furthermore, the shield may have additional edge protection on top and bottom, close to the winding end.

FIG. 3 shows a winding arrangement 2 comprising a core 5 with three wound limbs 10, 11, 12. Each of the wound limbs 10, 11, 12 is associated with a different phase. Each of the wound limbs 10, 11, 12 can have a winding arrangement 2 as shown in FIG. 2. In each case, a shield 9 is located on the outermost winding. The shields 9 cover an angular range of less than 180° so that the shields 9 do not extend into the gaps between the wound limbs 10, 11, 12. This has the advantage that extra space for the shields 9 between the wound limbs 10, 11, 12 is not required and the dimension of the core 5 has not to be increased. Accordingly, an increase of the core limb pitch, which would lead to an increase of no-load losses in the transformer, can be avoided.

FIG. 4 shows a further embodiment of a shield 9 for a winding arrangement 2. In this example, the shield 9 is in the form of a conductive net. The shield 9 may be wrapped about the outermost winding 6 as shown in FIG. 2. The shield 9 comprises a reinforcement 13 at edges and corners. The shield 9 can be fixed to the outer surface of the winding arrangement 2 by mechanical fasteners or by gluing, for example. The mechanical fasteners can be in the form of insulation supports. As an example, supports for the windings can be extended such that also a fixation of the shield 9 is accomplished.

FIG. 5 shows a transformer 1 comprising a winding arrangement 2 and an on-load tap changer 3. The winding arrangement 2 and on-load tap changer 3 are located in an oil-filled tank 15.

The winding arrangement 2 is the same as the winding arrangement 2 from FIG. 3 but shown from the opposite side. The position of the shields 9 is indicated with dotted lines. However, the shields 9 are positioned on the sides of the wound limbs which face away from the viewer.

The on-load tap changer 3 is connected to lead exits 14 of the regulating windings (only some of connections depicted). Due to the limited angular range of the shields 9, the connection of the lead exits 14 is not affected.

It is also possible that the shields 9 have openings for the lead exits 14. According to an example not in accordance with the claims, in this case, the shields 9 may extend about almost the entire circumference of the wound limbs 10, 11, 12 apart from a small gap for preventing circular current flows. The gap may extend along the entire length of the shield 9 in the direction of the winding axis. According to an example not in accordance with the claims, the shields 9 may cover an angular range of almost 360°, e.g., 340° or more. The shield 9 may have openings for the lead exits 14 in addition to the gap. It is also possible that the gap provides the openings for the lead exits 14.

In the following, characteristic values for a transformer with tie-in resistors and for a transformer with a shield design are compared to each other.

In both cases, the tap changer has a plus-minus regulation and graded neutral level. The connection is a three-phase star point connection.

For a transformer design without tie-in resistor and without shield, the maximum AC recovery voltage was 57.1 kV, which was above the maximum allowable level of 35 kV.

When using tie-in resistors, about 3.1% of additional no-load losses were added. For the capacitances, the following values were obtained:

$$C 1 = 1.776 nF$$

$$C 2 = 0.995 nF .$$

By the tie-in resistors, the maximum AC recovery voltage was reduced to 16.8 kV and, thus, is below the allowable level.

For comparison, an external shield was used instead of the tie-in resistor. The external shield is located on the neutral regulation and connected to neutral end.

In this case, the following values for the capacitances were obtained:

$$C 1 = 1.776 nF$$

$$C 2 = 3.126 nF .$$

Accordingly, C2 is highly increased by using the external shield. Due to the increase of C2, the maximum AC recovery voltage decreases. In the example, a maximum AC recovery voltage was calculated as 32.5 kV and is, thus, below the allowable maximum level.

Overall, when using the external shield design instead of tie-in resistors, the AC recovery voltage can be kept below the allowable level while the additional costs and losses of tie-in resistors can be avoided. Accordingly, a power transformer with an improved environment and efficiency index is obtained. Furthermore, the shields can be easily retrofitted on a winding arrangement without requiring significant additional space.

### REFERENCE SIGNS

1 power transformer
2 winding arrangement
3 on-load tap changer
4 tank wall
5 core
6 outermost winding
7 inner winding
8 innermost winding
9 shield
10 limb
11 limb
12 limb
13 reinforcement
14 lead exit
15 tank

1. A power transformer for an on-load tap changer application, comprising a winding arrangement with a core, several windings wound around the core and a shield comprising a conductive or semiconductive material, the shield being located at an outer side of an outermost winding of the windings, wherein the shield covers an angular range of at most 270° about a winding axis.

2. The power transformer of claim 1,
wherein the outermost winding is a regulating winding comprising several lead exits for varying the transformer output voltage.

3. The power transformer of claim 1, wherein the shield is in the form of a layer of material.

4. The power transformer of claim 1, wherein the shield is in the form of a partial cylinder.

5. The power transformer of claim 1, wherein the shield is connected to a ground potential or to the regulation neutral or center point potential.

6. The power transformer of claim 1, wherein the shield covers an angular range of at least 45° about a winding axis.

7. The power transformer of claim 1, wherein the shield covers an angular range of less than 180° about a winding axis.

8. The power transformer of claim 1, wherein the shield is formed by a layer of insulating material to which conductive or semiconductive particles are added.

9. The power transformer of claim 1, wherein the shield is formed by a carbonized paper.

10. The power transformer of claim 1, wherein the shield comprises a conductive material, wherein the conductive material is a metal.

11. The power transformer of claim 1, wherein the core comprises several wound limbs, each comprising several windings and a shield located at an outer side of an outermost winding of the windings.

12. The power transformer of claim 11, being a three-phase power transformer, wherein each of the wound limbs is associated to a different phase.

13. The power transformer of claim 1, comprising an on-load tap changer electrically connected to the winding arrangement.

14. The power transformer of claim 1, comprising an oil-filled tank in which the winding-arrangement is located.

15. The power transformer of claim 1, comprises several wound limbs, wherein the shield does not extend into a space between adjacent wound limbs.
